(19) United States
(12) Patent Application Publication
(10) Pub. No.: US 2020/0251719 A1
(43) Pub. Date: Aug. 6, 2020

(54) COMPOSITE POSITIVE ELECTRODE ACTIVE MATERIAL, METHOD FOR PREPARING SAME, AND LITHIUM SECONDARY BATTERY COMPRISING SAME

(71) Applicants: Samsung SDI Co., Ltd., Yongin-si (KR); Seoul National University R&DB Foundation, Seoul (KR)

(72) Inventors: Hyunjei CHUNG, Yongin-si (KR); Hanseul KIM, Seoul (KR); Sung Wook DOO, Seoul (KR); Kyu Tae LEE, Seoul (KR); Jungwoo LIM, Seoul (KR); Aram CHOI, Seoul (KR)

(21) Appl. No.: 16/857,466

(22) Filed: Apr. 24, 2020

Related U.S. Application Data
(63) Continuation-in-part of application No. PCT/KR2018/011547, filed on Sep. 28, 2018.

(30) Foreign Application Priority Data
Oct. 25, 2017 (KR) 10-2017-0139555
Apr. 26, 2019 (KR) 10-2019-0049393
May 17, 2019 (KR) 10-2019-0058373

(51) Int. Cl. H01M 4/134; H01M 4/131; H01M 4/525; H01M 4/505; H01M 4/36; H01M 4/04; H01M 10/0525; H01M 10/0569

(52) U.S. Cl. CPC H01M 4/134; H01M 4/131; H01M 4/525; H01M 4/505; H01M 2004/028; H01M 4/0471; H01M 4/364; H01M 10/0525; H01M 10/0569; H01M 4/366

(57) ABSTRACT

A composite positive electrode active material includes: a lithium transition metal oxide having an α-NaFeO₂ layered crystal structure; and a coating film including a lithium metal oxide on a (003) crystal plane of the lithium transition metal oxide, a method of preparing the same, and a lithium secondary battery including a positive electrode including the composite positive electrode active material.

### CROSS-REFERENCE TO RELATED APPLICATION

This application is a continuation-in-part of International Application PCT/KR2018/011547 having an international filing date of Sep. 28, 2018, which claims priority to and the benefit of Korean Patent Application No. 10-2017-0139555, filed in the Korean Intellectual Property Office on Oct. 25, 2017, the entire content of which is incorporated herein by reference. This application also claims priority to Korean Patent Application No. 10-2019-0049393, filed in the Korean Intellectual Property Office on Apr. 26, 2019; and Korean Patent Application No. 10-2019-0058373, filed in the Korean Intellectual Property Office on May 17, 2019, the entire content of each of which are incorporated herein by reference.

### BACKGROUND

### 1. Field

One or more aspects of embodiments of the present disclosure relate to a composite positive electrode active material, a method of preparing the same, and a lithium secondary battery including the same.

### 2. Description of the Related Art

Lithium secondary batteries have high voltage and high energy density, and thus may be used for various applications. For example, in the field of electric vehicles and/or the like, a lithium secondary battery that is capable of operating at high temperatures, capable of being charged with or discharging a large quantity of electricity, and having excellent discharge capacity and/or lifespan characteristics for long-term use is beneficial.

Lithium cobalt oxide is used as a positive electrode active material for lithium secondary batteries, due to its very high energy density. However, lithium cobalt oxide may lead to deteriorated battery characteristics due to side reactions with an electrolytic solution in a high voltage range. Therefore, improvements in this regard are beneficial.

### SUMMARY

One or more aspects of embodiments of the present disclosure are directed toward a composite positive electrode active material that allows easy intercalation/deintercalation of lithium.

One or more aspects of embodiments of the present disclosure are directed toward a method of preparing the above-described composite positive electrode active material.

One or more aspects of embodiments of the present disclosure are directed toward a lithium secondary battery having improved output characteristics by employing a positive electrode including the above-described composite positive electrode active material.

One or more example embodiments of the present disclosure provide a composite positive electrode active material including: a lithium transition metal oxide having an α-NaFeO₂ layered crystal structure; and a coating film including a lithium metal oxide and arranged (e.g., selectively arranged) on the (003) crystal plane of the lithium transition metal oxide.

One or more example embodiments of the present disclosure provide a method of preparing the above-described composite positive electrode active material, the method including: mixing a solvent, a lithium precursor, a metal (M) precursor of a lithium metal oxide, and a metal precursor of a lithium transition metal oxide having an α-NaFeO₂ layered crystal structure to obtain a composite positive electrode active material precursor composition;

adding a chelating agent to the composite positive electrode active material precursor composition and mixing the resultant to form a gel;

performing a first thermal treatment on the gel to obtain a first thermal treatment product; and

performing a second thermal treatment on the first thermal treatment product and then cooling the resultant at a cooling rate of about 5° C./min or less.

One or more example embodiments of the present disclosure provide a method of preparing the above-described composite positive electrode active material, the method including: mixing a lithium precursor and a metal (M) precursor of a lithium metal oxide with a solvent to obtain a lithium metal oxide precursor composition;

adding, to the lithium metal oxide precursor composition, a lithium transition metal oxide having an α-NaFeO₂ layered crystal structure, and mixing the resultant to form a gel;

performing a first thermal treatment on the gel to obtain a first thermal treatment product; and

performing a second thermal treatment on the first thermal treatment product and then cooling the resultant at a cooling rate of about 5° C./min or less.

One or more example embodiments of the present disclosure provide a lithium secondary battery including a positive electrode including the above-described positive electrode active material.

A composite positive electrode active material having a coating film only on the crystal plane oriented in (e.g., normal to) the c-axis direction may have a smaller charge transfer resistance than a composite positive electrode active material having (e.g., also having) a coating film on crystal planes oriented in the a-axis and b-axis directions. A lithium secondary battery having improved output characteristics may be manufactured using a positive electrode containing the composite positive electrode active material according to any of the embodiments.

### BRIEF DESCRIPTION OF THE DRAWINGS

FIG. 1A schematically illustrates a structure of a composite positive electrode active material according to an embodiment.

FIG. 1B is a schematic view of a lithium secondary battery according to an example embodiment.

FIGS. 2A and 2B are X-ray diffraction (XRD) plots at 25° C. of the composite positive electrode active materials of Examples 1 to 3, and the lithium cobalt oxide of Comparative Example 1.

FIGS. 3A and 3B are XRD plots of the composite positive electrode active material of Example 1 and the lithium cobalt oxide of Comparative Example 1, respectively, before and immediately after thermal treatment at 900° C. and after cooling post-thermal treatment.

FIGS. 4A to 4C are transmission electron microscope (TEM) and energy dispersive X-ray spectroscopy (EDS) mapping images of the composite positive electrode active material of Example 1.

FIGS. 5A to 5C are TEM and EDS mapping images of the composite positive electrode active material of Comparative Example 2.

FIG. 6 illustrates the results of EDS performed for the composite positive electrode active material of Example 1.

FIG. 7A is a scanning transmission electron microscope (STEM) mapping image of the composite positive electrode active material of Example 1.

FIG. 7B is an enlarged STEM image showing the atomic arrangement at the interface between LiCoO₂ and a Li₂SnO₃ coating film in the composite positive electrode active material prepared in Example 1.

FIG. 7C illustrates the results of fast Fourier transformation (FFT) pattern analysis of the STEM image of FIG. 7B.

FIG. 8A is a structural representation of the crystalline structure of LiCoO₂ as projected in the direction. FIG. 8B is a structural representation of the crystalline structure of Li₂SnO₃ as projected in the [310] direction. FIGS. 9A and 9B are structural representations of the crystalline structure of LiCoO₂ and the crystalline structure of Li₂SnO₃, respectively, as projected in the [001] direction.

FIG. 10 is a graph illustrating rate characteristics of coin cells manufactured according to Manufacture Example 1 and Comparative Manufacture Example 2.

FIG. 11 is a graph showing the impedance (e.g., charge transfer resistance) of the composite positive electrode active material of Example 1 and the composite positive electrode active material of Comparative Example 2.

### DETAILED DESCRIPTION

Hereinafter, example embodiments of a composite positive electrode active material, a method of preparing the same, and a lithium secondary battery employing a positive electrode including the composite positive electrode active material will be described in further detail.

As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, steps, operations, elements, and/or components, but do not preclude the presence or addition of one or more other features, steps, operations, elements, components, and/or groups thereof.

As used herein, expressions such as “at least one of,” “one of,” and “selected from,” when preceding a list of elements, modify the entire list of elements and do not modify the individual elements of the list. As used herein, the term “and/or” includes any and all combinations of one or more of the associated listed items. Further, the use of “may” when describing embodiments of the present disclosure refers to “one or more embodiments of the present disclosure”.

One or more example embodiments of the present disclosure provide a composite positive electrode active material including: a lithium transition metal oxide having an α-NaFeO₂ layered crystal structure; and a coating film including a lithium metal oxide arranged (e.g., selectively arranged) on the (003) crystal plane of the lithium transition metal oxide.

In the composite positive electrode active material, the coating film including the lithium metal oxide may be disposed (e.g., selectively disposed) on a plane where intercalation and deintercalation of lithium ions of the lithium transition metal oxide having an α-NaFeO₂ layered crystal structure does not occur (e.g., on a crystal plane not associated with intercalation and deintercalation of lithium ions), or on a crystal plane oriented in (e.g., normal to) the c-axis direction of the lithium transition metal oxide. In some embodiments, for example, the coating film including the lithium metal oxide may be present only on the surfaces of the lithium transition metal oxide that correspond to crystal planes parallel to the c-axis direction (such as (003) and similar planes), and may be excluded from other surfaces that do not correspond to crystal planes parallel to the c-axis direction. For example, the coating film including the lithium metal oxide may not be present or included on surfaces that do not correspond to crystal planes parallel to the c-axis direction.

The lithium metal oxide may have a monoclinic crystal system and a C2/c space group structure. When the lithium metal oxide has this crystal structure, a mismatch at the interface between the lithium metal oxide and the lithium transition metal oxide having an α-NaFeO₂ layered crystal structure may be minimized or reduced.

The lithium metal oxide may be, for example, a compound represented by Formula 1:

Li₂MO₃ [Formula 1]

In Formula 1, M may be a metal having an oxidation number of +4. In some embodiments, M may be selected from tin (Sn), zirconium (Zr), tellurium (Te), ruthenium (Ru), titanium (Ti), manganese (Mn), lead (Pb), hafnium (Hf), and combinations thereof, each being in the +4 oxidation state.

The lithium metal oxide may be, for example, at least one selected from Li₂SnO₃, Li₂ZrO₃, Li₂TeO₃, Li₂RuO₃, Li₂TiO₃, Li₂MnO₃, Li₂PbO₃, Li₂HfO₃, and combinations thereof. In some embodiments, the lithium metal oxide may be Li₂SnO_{3.}

An amount of the lithium metal oxide may be about 5 mol % or less, for example, about 0.1 mol % to about 5 mol %, or about 2 mol % to about 5 mol %, based on a total amount of the lithium transition metal oxide having an α-NaFeO₂ layered crystal structure and the lithium metal oxide. When the amount of the lithium metal oxide is within these ranges, the coating film may be on the crystal plane normal to the c-axis direction of the lithium transition metal oxide, and thus may effectively inhibit an increase in charge transfer resistance.

The lithium transition metal oxide having an α-NaFeO₂ layered crystal structure may be, for example, lithium cobalt oxide (LiCoO₂). Lithium cobalt oxide has a layered α-NaFeO₂ structure in which CoO₂ and Li layers continuously alternate, and has an R-3 m space group. Because lithium cobalt oxide can be produced on a mass scale and exhibits good battery characteristics, lithium cobalt oxide is well suited for commercialization. However, in a high voltage range of 4.4 V or higher, cobalt atoms may elute from the lithium cobalt oxide into the electrolyte, resulting in side reactions with the electrolyte and thereby deteriorating the battery characteristics. Therefore, to enable reversible charging capacity in a high voltage range of 4.4 V or greater, it is necessary or desired to coat the surface of the lithium cobalt oxide.

The surface of the lithium cobalt oxide may be coated with a metal oxide-based or phosphate-based material. According to this method, the entire surface of lithium cobalt oxide may be coated with the metal oxide-based or phosphate-based material. However, a lithium secondary battery including a positive electrode using the coated lithium cobalt oxide may have reduced output characteristics due to an increase in charge transfer resistance.

To resolve the above-described problems, a coating film may be formed (e.g., selectively formed) on the crystal plane normal to the c-axis direction of the lithium cobalt oxide, (e.g., on a crystal plane other than the crystal planes through which lithium ions intercalate/deintercalate), to effectively inhibit an increase in charge transfer resistance without interfering with the intercalation and deintercalation of lithium.

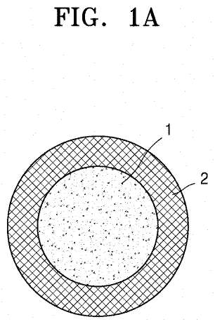

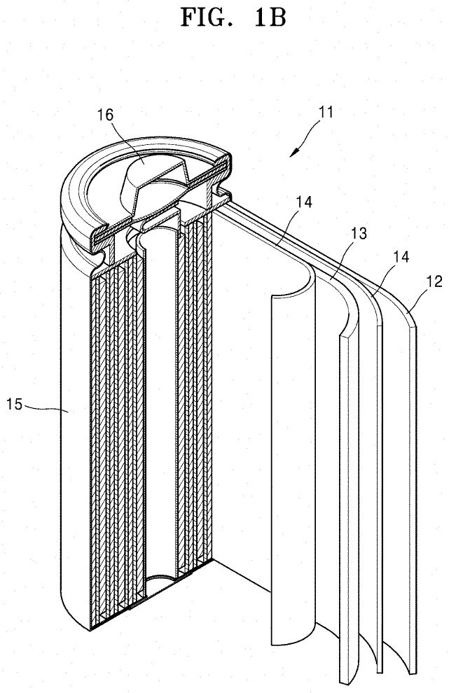

FIG. 1A is a schematic view illustrating a structure of a composite positive electrode active material according to an embodiment.

Referring to FIG. 1A, the composite positive electrode active material according to an embodiment may have a structure in which a coating film 2 including lithium metal oxide is on (e.g., stacked on) a surface of a lithium transition metal oxide 1 having an α-NaFeO₂ layered crystal structure. The coating film 2 may be (e.g., selectively be) on the (003) crystal plane of the lithium transition metal oxide 1 having α-NaFeO₂ layered crystal structure.

The coating film may have a thickness of about 1 nm to about 100 nm, for example, about 1 nm to about 80 nm, or about 10 nm to about 60 nm. When the thickness of the coating film is within these ranges, an increase in charge transfer resistance may be effectively inhibited due to coating on the lithium transition metal oxide.

The coating film may be a substantially continuous or discontinuous film.

The composite positive electrode active material according to one or more embodiments may have a layered structure, in which the lithium metal oxide on the (003) crystal plane of the lithium transition metal oxide, and the lithium transition metal oxide having an α-NaFeO₂ layered crystal structure are both (e.g., similarly) epitaxially grown in the c-axis direction. This layered structure epitaxially grown in the c-axis direction may be identified or observed via transmission electron microscopy (TEM) image and/or via pattern analysis of a fast Fourier transformation (FFT) of the TEM image.

In the composite positive electrode active material according to one or more embodiments, LiCoO₂ and Li₂SnO₃ may both (e.g., simultaneously) exhibit a [hk0] zone axis pattern in the TEM-FFT image. The term “zone axis” refers to a direction of the intersection of faces belonging to the same zone, e.g., a direction of common edges, or for example, a direction parallel to the intersection of two or more families of lattice planes. The term “zone axis pattern” refers to a type or kind of diffraction pattern that can be observed in the TEM-FFT when the electron beam is directed toward the crystal along the zone axis. Unlike the composite positive electrode active material according to one or more embodiments, a composite positive electrode active material obtained according to related art coating methods may not exhibit a [hk0] zone axis.

Hereinafter, according to one or more embodiments, a method of preparing a composite positive electrode active material according to an embodiment will be described.

First, according to an embodiment, a first method of preparing a composite positive electrode active material according to an embodiment will be described.

A lithium precursor, a metal (M) precursor for forming the lithium metal oxide, and a metal precursor for forming the lithium transition metal oxide having an α-NaFeO₂ layered crystal structure may be mixed with a solvent to prepare a composite positive electrode active material precursor composition. The solvent may be ethanol, methanol, and/or isopropanol.

The amounts of the lithium precursor, the metal (M) precursor for forming the lithium metal oxide, and the metal precursor for forming the lithium transition metal oxide having an α-NaFeO₂ layered crystal structure may each be properly controlled or selected to attain a desired or suitable composition of the composite positive electrode active material.

In an embodiment, when the amount of the metal (M) precursor for forming the lithium metal oxide is x moles (where 0≤x≤0.1), the amount of the metal precursor for forming the lithium transition metal oxide having an α-NaFeO₂ layered crystal structure may be (1-x) moles, and the amount of the lithium precursor may be 1.03(1+2x) moles.

Subsequently, a chelating agent may be added to the precursor composition and then mixed together to form a gel. In the gel formation process, for example, the mixture may be thermally treated at about 30° C. to about 80° C. while stirring, and then dried to remove the solvent.

The chelating agent may capture the metal ions present in the solution to prevent or reduce the uneven distribution of the metal ions during sol and gel formation, thus facilitating mixing. The chelating agent may be, for example, an organic acid. The organic acid may be citric acid, acrylic acid, tartaric acid, and/or glycolic acid.

Subsequently, after the first thermal treatment is performed on the gel, a second thermal treatment may be performed on a first thermal treatment product, and then cooling (e.g., a cooling process) may be performed at a cooling rate of 5° C./min or less, to thereby obtain a desired or suitable composite positive electrode active material.

The first thermal treatment may be performed at a temperature of about 200° C. to about 550° C., and the second thermal treatment may be performed at a temperature of about 600° C. to about 950° C. When the first thermal treatment and the second thermal treatment are each performed within these temperature ranges, a composite positive electrode active material having a desired or suitable crystallinity may be obtained. The first thermal treatment and the second thermal treatment may each be performed for a set or predetermined time, while increasing the temperature under the drying air or oxygen atmosphere. The temperature may be increased, for example, at a rate of about 0.5° C./min to about 10° C./min.

In the cooling process, the cooling may be performed at a rate of, for example, about 0.1° C. to about 5° C., for example, about 1° C. to about 5° C. The cooling process may be performed, for example, after the second thermal treatment, while controlling the cooling rate within the above ranges in a furnace.

The composite positive electrode active material obtained according to the above-described preparation method may be subjected to pulverizing and sieving, as necessary or desired, to obtain a desired or suitable lithium cobalt oxide.

According to another embodiment, a second method of preparing a composite positive electrode active material according to an embodiment will be described.

A lithium precursor and a metal (M) precursor for forming a lithium metal oxide may be mixed with a solvent to obtain a lithium metal oxide precursor composition. The metal (M) precursor for forming the lithium metal oxide may be a material of the coating film.

Then, the lithium transition metal oxide having an α-NaFeO₂ layered crystal structure may be added to the lithium metal oxide precursor composition and then mixed together to form a gel. After a first thermal treatment is performed on the gel, a second thermal treatment may be performed on a first thermal treatment product, and then cooling may be performed at a cooling rate of 5° C./min or less, to thereby obtain a desired or suitable composite positive electrode active material.

In the above-described second method, the amounts of the lithium precursor, the metal (M) precursor for forming the lithium metal oxide, and the metal precursor for forming the lithium transition metal oxide having an α-NaFeO₂ layered crystal structure may each be properly controlled or selected to attain a desired or suitable composition of the composite positive electrode active material.

The lithium transition metal oxide having an α-NaFeO₂ layered crystal structure may be prepared according to available methods in the art. In the above—described second preparation method, the types or kinds of the solvent, the conditions for the first thermal treatment and the second thermal treatment, and the cooling conditions may be the same as those described above in connection with the first preparation method.

In the above-described first and second preparation methods, the metal (M) precursor for forming the lithium metal oxide may be, for example, at least one selected from tin chloride (SnCl₂), zirconium chloride (ZrCl₄), tellurium chloride (TeCl₄), ruthenium chloride (RuCl₄), titanium chloride (TiCl₄), manganese chloride (MnCl₄), hafnium chloride (HfCl₄), lead chloride (PbCl₄), zirconium nitrate, zirconium acetate, zirconium oxalate, tellurium nitrate, tellurium acetate, tellurium oxalate, tellurium chloride, ruthenium nitrate, ruthenium acetate, ruthenium oxalate, titanium nitrate, titanium acetate, titanium oxalate, manganese nitrate, manganese acetate, manganese oxalate, hafnium nitrate, hafnium acetate, hafnium oxalate, and combinations thereof.

The metal precursor for forming the lithium transition metal oxide having an α-NaFeO₂ layered crystal structure may be, for example, at least one selected from the group consisting of cobalt nitrate, cobalt acetate, cobalt oxalate, and cobalt chloride.

The lithium precursor may be lithium hydroxide, lithium nitrate, lithium acetate, lithium sulfate, lithium fluoride, or any mixture thereof.

In one or more embodiments, the lithium cobalt oxide may have an average particle diameter of, for example, 0.05 μm to about 20 μm. The c-axis orientation degree of lithium cobalt oxide (LiCoO₂) may be preferentially very closely related with the (003) crystal plane.

According to one or more embodiments, in a method of preparing a composite positive electrode active material according to an embodiment, the lithium metal oxide is coated on a plane of lithium cobalt oxide where intercalation and deintercalation of lithium do not occur, e.g., on the (003) crystal plane or on the crystal plane oriented in the c-axis direction. Without being bound by any particular mechanism or theory, it is thought that coating only the (003) crystal plane of the lithium cobalt oxide with a lithium metal oxide (such as Li₂SnO₃) is possible because a mismatch between the lithium-oxygen distance of the lithium cobalt oxide and the lithium-oxygen distance of Li₂SnO₃ coated on the (003) crystal plane of the lithium cobalt oxide is smaller than the lithium-oxygen distance mismatch when the lithium metal oxide such as Li₂SnO₃ is coated on a crystal plane of lithium cobalt oxide where intercalation/deintercalation of lithium ions occur. In some embodiments, for example, when the lithium metal oxide is dissolved (doped) in the lithium transition metal oxide at high temperature, the lithium metal oxide may selectively precipitate on a (003) crystal plane during and/or after cooling due to the more favorable lattice mismatch conditions described above. As such, the finally obtained composite positive electrode active material according to an embodiment may have a further stabilized structure. In the composite positive electrode active material in which Li₂SnO₃ is coated on the (003) plane of lithium cobalt oxide, a mismatch between the lithium-oxygen distance of the lithium cobalt oxide and the lithium-oxygen distance of Li₂SnO₃ may be as small as, for example, 0.1 Å or less.

When using the composite positive electrode active material according to any of the embodiments, a positive electrode having good chemical stability even under high-temperature charging and discharging conditions may be manufactured. A lithium secondary battery having improved output characteristics may be manufactured by using the composite positive electrode active material in the positive electrode

The lithium cobalt oxide may further include at least one element selected from magnesium (Mg), calcium (Ca), strontium (Sr), titanium (Ti), zirconium (Zr), boron (B), aluminum (Al), and fluorine (F). When a positive electrode is manufactured using the lithium cobalt oxide further including at least one of these elements, a lithium secondary battery including the positive electrode may have further improved electrochemical characteristics. The amount of the at least one element may be about 0.001 mole to about 0.1 mole with respect to 1 mole of cobalt.

Hereinafter, a method of manufacturing a lithium secondary battery using a composite positive electrode active material according to any of the above-described embodiments will be described in more detail. In particular, embodiments of a method of manufacturing a lithium secondary battery including a positive electrode, a negative electrode, a lithium salt-containing non-aqueous electrolyte, and a separator will be described.

The positive electrode and the negative electrode may be manufactured by coating a positive electrode active material layer-forming composition and a negative electrode active material layer-forming composition on respective current collectors, and then drying the resultants.

The positive electrode active material layer-forming composition may be prepared by mixing a positive electrode active material, a conducting agent, a binder, and a solvent, wherein a composite positive electrode active material according to any of the above-described embodiments may be used as the positive electrode active material.

The binder may facilitate binding of the positive active material to the conducting agent and/or to the current collector. The amount of the binder may be about 1 part to about 50 parts by weight with respect to 100 parts by weight of the total weight of the positive electrode active material. Non-limiting examples of the binder include polyvinylidene fluoride (PVDF), polyvinyl alcohol, carboxymethylcellulose (CMC), starch, hydroxypropylcellulose, reproduced cellulose, polyvinylpyrrolidone, tetrafluoroethylene, polyethylene, polypropylene, ethylene-propylene-diene terpolymer (EPDM), sulfonated EPDM, styrene butylene rubber, fluorine rubber, and/or various copolymers. The amount of the binder may be about 1 part to about 5 parts by weight based on 100 parts by weight of the total weight of the positive electrode active material. When the amount of the binder is within this range, a binding force of the positive electrode active material layer to the current collector may be satisfactorily strong.

The conducting agent may be any material that does not cause an unwanted chemical change in the lithium metal battery and has conductivity. Non-limiting examples of the conducting agent include graphite (such as natural graphite and/or artificial graphite); carbonaceous materials (such as carbon black, acetylene black, Ketjen black, channel black, furnace black, lamp black, and/or summer black); conductive fibers (such as carbon fibers and/or metal fibers); carbon fluoride; metal powder (such as aluminum and/or nickel powder); conductive whiskers (such as zinc oxide and/or potassium titanate); a conductive metal oxide (such as titanium oxide); and/or a conductive organic material (such as a polyphenylene derivative).

The amount of the conducting agent may be about 1 part to about 5 parts by weight based on 100 parts by weight of the total weight of the positive electrode active material. When the amount of the conducting agent is within this range, a finally obtained positive electrode may have improved conductivity characteristics.

A non-limiting example of the solvent may be N-methylpyrrolidone.

The amount of the solvent may be about 10 parts to about 200 parts by weight based on 100 parts by weight of the total weight of the positive electrode active material. When the amount of the solvent is within this range, the positive electrode active material layer may be formed easily.

The positive current collector may have a thickness of about 3 μm to about 500 μm, and may be formed of any suitable material as long as it has high conductivity without causing an unwanted chemical change in the battery. For example, the material of the positive current collector may be stainless steel, aluminum, nickel, titanium, heat-treated carbon, and/or aluminum or stainless steel that is surface-treated with carbon, nickel, titanium, silver, and/or the like. The positive current collector may have an uneven surface having fine irregularities to enhance the binding force with the positive electrode active material, and may have any suitable form, for example, a film, a sheet, a foil, a net, a porous body, a foam, and/or a non-woven fabric.

The negative electrode active material layer-forming composition may be separately prepared by mixing a negative electrode active material, a binder, a conducting agent, and a solvent together.

The negative electrode active material may be a material that allows intercalation and deintercalation of lithium ions. Non-limiting examples of the negative electrode active material include: a carbonaceous material (such as graphite and carbon); lithium metal and/or an alloy thereof; and a silicon oxide-based material. In some embodiments, the negative electrode active material may be silicon oxide.

The amount of the binder may be about 1 part to about 50 parts by weight based on 100 parts by weight of the total weight of the negative electrode active material. Non-limiting examples of the binder are the same as those listed above in connection with the preparation of the positive electrode.

The amount of the conducting agent may be about 1 part to about 5 parts by weight based on 100 parts by weight of the total weight of the negative electrode active material. When the amount of the conducting agent is within this range, the finally obtained negative electrode may have improved conductivity characteristics.

The amount of the solvent may be about 10 parts to about 200 parts by weight based on 100 parts by weight of the total weight of the negative electrode active material. When the amount of the solvent is within this range, the negative electrode active material layer may be easily formed.

Non-limiting examples of the conducting agent and the solvent used herein may be the same as those listed above in connection with the preparation of the positive electrode.

The negative electrode current collector may have a thickness of, for example, about 3 um to about 500 um, and a material thereof is not particularly limited so long as it has high conductivity without causing an unwanted chemical change in the battery. For example, the material of the negative electrode current collator may be copper, stainless steel, aluminum, nickel, titanium, heat-treated carbon, and/or copper or stainless steel surface-treated with carbon, nickel, titanium, silver, and/or an aluminum-cadmium alloy. For example, like the positive electrode current collector, the negative electrode current collector may have an uneven surface having fine projections and recesses to enhance the binding force with the negative electrode active material. The negative electrode current collector may be provided in any of various forms, including a film, a sheet, a foil, a net, a porous structure, a foam, and/or a non-woven fabric.

Then, a separator may be disposed between the positive electrode and the negative electrode manufactured according to the above-described processes.

The separator may have a pore diameter of about 0.01 μm to about 10 μm and a thickness of about 5 μm to about 300 μm. Non-limiting examples of the separator include an olefin-based polymer (such polypropylene and/or polyethylene); and sheets or non-woven fabric formed of glass fiber. When a solid electrolyte, for example, a polymer electrolyte is used, the solid electrolyte may also serve as the separator.

The lithium salt-containing non-aqueous electrolyte may include a non-aqueous electrolyte and a lithium salt. The non-aqueous electrolyte may be a non-aqueous liquid electrolyte, an organic solid electrolyte, or an inorganic solid electrolyte.

Non-limiting examples of the non-aqueous liquid electrolyte include aprotic organic solvents (such as N-methyl-2-pyrrolidone, propylene carbonate, ethylene carbonate, butylene carbonate, dimethyl carbonate, diethyl carbonate, gamma-butyrolactone, 1,2-dimethoxyethane, 2-methyl tetrahydrofuran, dimethylsulfoxide, 1,3-dioxolane, N,N-formamide, N,N-dimethylformamide, acetonitrile, nitromethane, methyl formate, methyl acetate, trimethoxy methane, a dioxolane derivative, sulfolane, methylsulfolane, 1,3-dimethyl-2-imidazolidinone, a propylene carbonate derivative, a tetrahydrofuran derivative, ether, methyl propionate, and ethyl propionate).

Non-limiting examples of the organic solid electrolyte include a polyethylene derivative, a polyethylene oxide derivative, a polypropylene oxide derivative, a phosphoric acid ester polymer, polyvinyl alcohol, and polyfluoride vinylidene.

Non-limiting examples of the inorganic solid electrolyte include Li₃N, Lil, Li₅NI₂, Li₃N—LiI—LiOH, Li₂SiS₃, Li₄SiO₄, Li₄SiO₄—LiI—LiOH, and Li₃PO₄—Li₂S—SiS₂.

Non-limiting examples of the lithium salt, which may be soluble in the non-aqueous electrolyte, include LiCI, LiBr, Lil, LiCIO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, (FSO₂)₂NLi, lithium chloroborate, a lower aliphatic lithium carboxylate, and lithium tetraphenyl borate.

FIG. 1B is a schematic cross-sectional view illustrating a structure of a lithium secondary battery 11 according to an embodiment.

Referring to FIG. 1B, the lithium secondary battery 11 according to an embodiment may include a positive electrode 13 including a composite positive electrode active material according to any of the above-described embodiments; a negative electrode 12; a separator 14 between the positive electrode 13 and the negative electrode 12; an electrolyte impregnated into the positive electrode 13, the negative electrode 12, and the separator 14; a battery case 15; and a cap assembly 16 sealing the battery case 15. This lithium secondary battery 11 may be manufactured by sequentially stacking the positive electrode 13, the separator 14, and the negative electrode 12 in this stated order to form a stack, winding this stack into a spiral form, and encasing the wound stack in the battery case 15. The battery case 15 may then be sealed with the cap assembly 16, thereby completing the manufacturing of the lithium secondary battery 10.

The lithium secondary battery according to one or more embodiments may have improved output characteristics, and thus may be used in a battery cell for use as a power source of a small device, and may also be used as a unit battery of a medium-large size battery pack or battery module, including a plurality of battery cells, for use as a power source of a medium-large size device.

Non-limiting examples of the medium-large size device include electric vehicles (EVs), including hybrid electric vehicles (HEVs) and plug-in hybrid electric vehicles (PHEVs); electric two-wheeled vehicles, including E-bikes and E-scooters; power tools; power storage devices; and/or the like. However, embodiments are not limited thereto.

Embodiments of the present disclosure will now be described in more detail with reference to the following examples. However, these examples are provided only for illustrative purposes, and are not intended to limit the scope of the one or more embodiments of the present disclosure.

### (Preparation of Composite Positive Electrode Active Material)

### EXAMPLE 1

LiNO₃, Co(NO₃)₂.6H₂O, and SnCl₂ were mixed in a molar ratio of about 1.05 0.95: 0.05 and then dissolved in ethanol to prepare a composite positive electrode active material precursor-containing ethanol solution. The amount of ethanol was about 200 parts by weight with respect to 100 parts by weight of a total amount of the composite positive electrode active material precursor.

Citric acid (as a chelating agent) was dissolved in the obtained solution in a molar ratio of 1:1 with respect to a total amount of cations present in the solution. The resulting solution was dried at a temperature of about 60° C. for about 10 hours to remove the solvent from the solution, thereby obtaining a gel.

The gel was thermally treated at about 300° C. for about 5 hours (first thermal treatment) to obtain a powder. During the thermal treatment, the temperature increase rate was about 10° C./min. The obtained powder was thermally treated again at about 900° C. for about 10 hours (second thermal treatment), and the resulting product was cooled in a furnace to thereby obtain a composite positive electrode active material. In the first thermal treatment and the second thermal treatment, the temperature increase rate was about 10° C./min and the cooling rate was about 1° C./min. The composite positive electrode active material obtained according to Example 1 had a structure including LiCoO₂ (e.g., a LiCoO₂ core) and a Li₂SnO₃ coating film on the (003) crystal plane (c-axis oriented crystal plane) of LiCoO_{2.} The Li₂SnO₃ coating film had a thickness of about 50 nm, and a Li₂SnO₃ content of about 5 mol %. EXAMPLES 2-3

Additional composite positive electrode active materials were prepared in substantially the same manner as in Example 1, except that the amounts of LiNO₃, Co(NO₃)₂.6H₂O, and SnCl₂ were varied so that the finally obtained composite positive electrode active materials had a Li₂SnO₃ content of about 2 mol % or about 1 mol %, respectively.

### EXAMPLES 4-5

Composite positive electrode active materials were prepared in substantially the same manner as in Example 1, except that, in the process of cooling in a furnace, the cooling rate was varied to about 3° C./min and about 5° C./min, respectively.

### EXAMPLE 6

LiNO₃ and Co(NO₃)₂.6H₂O were dissolved in ethanol in a molar ratio of Li:Co=1.03:1 to prepare a metal precursor-containing ethanol solution. The amount of ethanol was about 200 parts by weight with respect to 100 parts by weight of a total amount of the metal precursor.

Citric acid was dissolved in the metal precursor ethanol solution in a molar ratio of 1:1 with respect to a total amount of cations present in the solution. The resulting solution was dried at a temperature of about 60° C. for about 10 hours to remove the solvent, thereby obtaining a gel.

After the obtained gel was thermally treated at about 300° C. for about 5 hours (first thermal treatment), a powder was obtained. During this thermal treatment process, the temperature increase rate was about 10° C./min. The obtained powder was thermally treated again at about 900° C. for about 10 hours (second thermal treatment) to thereby obtain LiCoO_{2.} At this time, the temperature increase rate was about 10° C./min, and the cooling rate was about 10° C./min or greater.

Separately, LiNO₃ and tin (IV) 2-ethylhexano-isopropoxide (Sn(OOC₈H₁₅)₂(OC₃H₇)₂)) were dissolved in isopropanol (IPA) in a ratio of 2:1. At this time, a total amount of Li₂SnO₃, a coating material, was controlled to be about 5 mol % with respect to LiCoO_{2.}

The LiCoO₂ obtained according to the above-described processes was dispersed in the solution and then stirred at room temperature (25° C.) for about 20 hours. This solution was heated to evaporate the solvent and obtain a product in gel form. After the product in gel form was calcinated at about 150° C. for 10 hours, a powder was obtained. The obtained powder was calcinated again at about 850° C. for about 5 hours, and finally LiCoO₂ coated with Li₂SnO₃ was obtained through wet coating. In the first thermal treatment and the second thermal treatment, the temperature increase rate was about 10° C./min, and the cooling rate was about 1° C./min.

### EXAMPLE 7

A composite positive electrode active material (LiCoO₂ having a Li₂ZnO₃ coating film on the (003) crystal plane) was obtained in substantially the same manner as in Example 1, except that zirconium (IV) acetylacetonate (Zr(C₅H₈O₂)₂), instead of SnCl₂, was used. In the first thermal treatment and the second thermal treatment, the temperature increase rate was about 10° C./min, and the cooling rate was about 1° C./min. Zirconium chloride was added such that the Li₂ZnO₃ coating film has a Li₂ZnO₃ content of about 5 mol %.

### COMPARATIVE EXAMPLE 1

LiNO₃ and Co(NO₃)₂.6H₂O were dissolved in ethanol in a molar ratio of Li:Co=1.03:1 to prepare a metal precursor-containing ethanol solution. The amount of ethanol was about 200 parts by weight respect to 100 parts by weight of a total amount of the metal precursor.

Citric acid was dissolved in the metal precursor ethanol solution in a molar ratio of 1:1 with respect to a total amount of cations present in the solution. The resultant was dried at a temperature of about 60° C. for about 10 hours until the solvent in the solution disappeared, to thereby obtain a gel.

After the obtained gel was thermally treated at about 300° C. for about 5 hours (first thermal treatment), a powder was obtained. During this thermal treatment process, the temperature increase rate was about 10° C./min. The obtained powder was thermally treated again at about 900° C. for about 10 hours (second thermal treatment) to thereby obtain LiCoO_{2.} At this time, the temperature increase rate was about 10° C./min, and the cooling rate was about 10° C./min.

### COMPARATIVE EXAMPLE 2

LiNO₃ and tin (IV) 2-ethylhexano-isopropoxide (Sn(OOC₈H₁₅)₂(OC₃H₇)₂)) were dissolved in isopropanol (IPA) in a molar ratio of 2:1. At this time, a total amount of Li₂SnO₃, a coating material, was controlled to be about 5 mol % with respect to LiCoO₂.

The LiCoO₂ obtained according to Comparative Example 1 was dispersed in this solution, and then stirred at room temperature (25° C.) for about 20 hours. The solution was heated at about 60° C. for about 20 hours to evaporate the solvent and obtain a product in gel form. After the product in gel form was calcinated at about 150° C. for 10 hours, a powder was obtained. The obtained powder was calcinated again at about 850° C. for about 5 hours, and finally a composite positive electrode active material was obtained through wet coating. In the first thermal treatment and the second thermal treatment, the temperature increase rate was about 10° C./min, and the cooling rate was about 10° C./min.

The composite positive electrode active material obtained according to Comparative Example 2 had a structure including LiCoO₂ (e.g., a LiCoO₂ core) and a Li₂SnO₃ coating film on the crystal planes in all directions of the LiCoO₂ (e.g., on all surfaces of the LiCoO₂ core).

### (Manufacture Examples of Lithium Secondary Battery)

### MANUFACTURE EXAMPLE 1

A coin cell was manufactured as follows using the composite positive electrode active material prepared in Example 1.

96 g of the lithium cobalt oxide (LiCoO₂) obtained in Example 1, 2 g of polyvinylidene fluoride, 47 g of N-methylpyrrolidone as a solvent, and 2 g of carbon black as a conducting agent were mixed together with to prepare a substantially uniformly dispersed slurry for forming a positive electrode active material layer.

The prepared slurry was coated on an aluminum foil using a doctor blade to form a thin electrode plate. Then, the electrode plate was dried at about 135° C. for about 3 hours, roll-pressed, and then vacuum-dried to thereby manufacture a positive electrode.

A 2032-type coin cell (e.g., CR2032) was manufactured using the positive electrode and a lithium metal negative electrode. A porous polyethylene (PE) film separator (having a thickness of about 16 μm) was disposed between the positive electrode and the lithium metal negative electrode, and then an electrolyte was injected thereinto to thereby manufacture the 2032-type coin cell.

The electrolyte used was a solution of 1.3 M LiPF6 dissolved in a mixed solvent of ethylene carbonate (EC), ethyl methyl carbonate (EMC), and dimethyl carbonate (DMC) in a volume ratio of about 3:4:3.

### MANUFACTURE EXAMPLES 2-7

Lithium secondary batteries were manufactured in substantially the same manner as in Manufacture Example 1, except that the composite positive electrode active materials prepared in Examples 2 to 7, instead of the composite positive electrode active material prepared in Example 1, were used, respectively.

### Comparative Manufacture Examples 1-2

Lithium secondary batteries were manufactured in substantially the same manner as in Manufacture Example 1, except that the composite positive electrode active materials prepared in Comparative Examples 1 and 2, instead of the composite positive electrode active material prepared in Example 1, were used, respectively.

### EVALUATION EXAMPLE 1

### Room-Temperature (25° C.) X-Ray Diffraction (XRD) Analysis

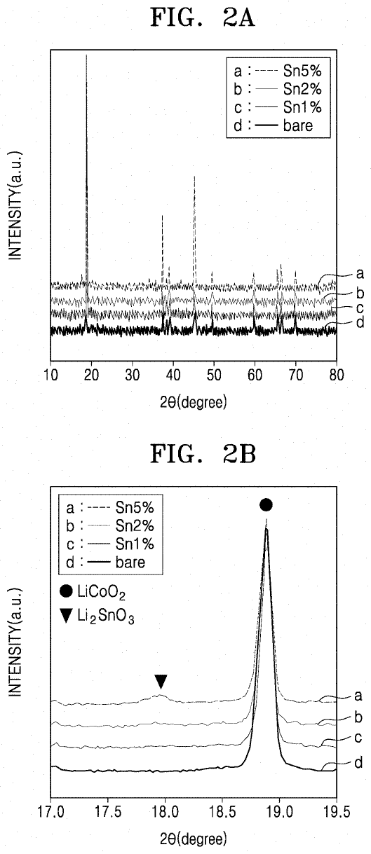

The composite positive electrode active materials prepared in Examples 1 to 3 and the lithium cobalt oxide prepared in Comparative Example 1 were analyzed at 25° C. by X-ray diffractometry (XRD). The XRD analysis was performed using a Bruker D2 phaser X-ray diffractometer with CuKa radiation (λ=1.5406Å), and the XRD results are shown in FIGS. 2A and 2B. In FIGS. 2A and 2B, “bare” denotes the lithium cobalt oxide of Comparative Example 1, and “Sn5%,” “Sn2%” and “Sn1%” denote the composite positive electrode active materials of Examples 1 to 3, respectively.

Referring to FIGS. 2A and 2B, in the composite positive electrode active materials of Examples 1 to 3, LiCoO₂ and Li₂SnO₃ phases were both observed (e.g., simultaneously). A peak appearing in the region of 28 at about 18.5° to about 19.3° corresponds to lithium cobalt oxide, and a peak appearing in the region of 28 of about 17.7° to about 18.3° corresponds to Li₂SnO_{3.}

In the positive electrode active materials including Li₂SnO₃ coated on LiCoO₂, regardless of the thermal treatment after the mixing with the tin precursor, peak broadening and peak shifting were not observed in the XRD pattern of LiCoO₂. In particular, in the composite positive electrode active material (having a Sn content of about 5 mol %) of Example 1, the (002) peak of Li₂SnO₃ was observed near 18°, indicating that doping of Sn into the structure of LiCoO₂ did not occur at room temperature, due to the low solubility limit at room temperature of Sn with respect to LiCoO₂.

### EVALUATION EXAMPLE 2

### High-Temperature XRD Analysis

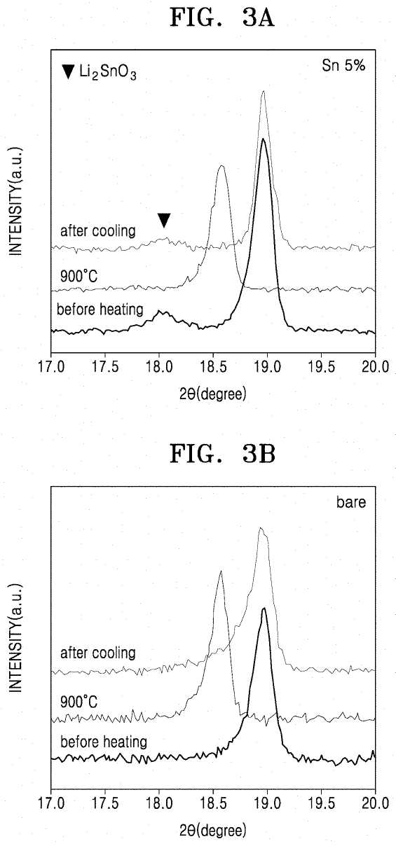

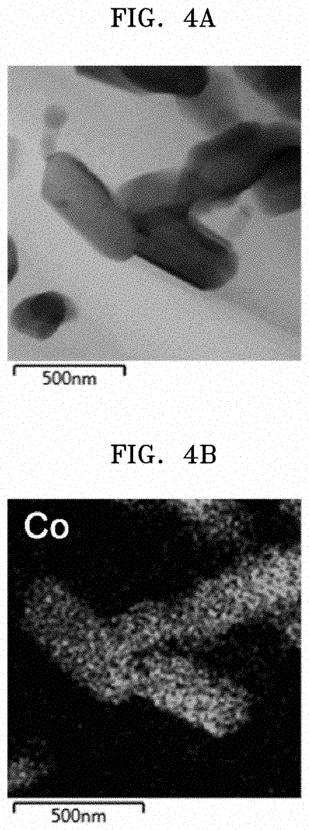

The composite positive electrode active material of Example 1 and the lithium cobalt oxide of Comparative Example 1 were analyzed by X-ray diffraction, before and immediately after thermal treatment at 900° C., and after cooling after the thermal treatment. The XRD analysis was performed using a Bruker D8 advance X-ray diffractometer with CuKα radiation (λ=1.5406Å), and the XRD results are shown in FIGS. 3A and 3B. In FIGS. 3A and 3B, “before heating” indicates the result before the thermal treatment at 900° C., “900° C.” indicates the result after the thermal treatment at 900° C., and “after cooling” indicates the result after cooling after the thermal treatment at 900° C.

Referring to FIG. 3A, in the composite positive electrode active material of Example 1, the (002) peak of Li₂SnO₃ at near 18° completely disappeared at high temperature (900° C.), and appeared again after the cooling. As shown in FIG. 3B, in the bare LiCoO₂ of Comparative Example 1, a large change in peak shape did not appeared at high temperature. However, in Example 1 coated with 5 mol % of Li₂SnO₃, peak broadness was observed. This means that, through reaction of Li₂SnO₃ with LiCoO₂ at high temperature, Sn was doped on LiCoO₂. In addition, it was found that, due to the low solubility of Sn at low temperature, phase separation into Li₂SnO₃ and LiCoO₂ occurred during the cooling, and Li₂SnO₃ was coated on the surface of LiCoO₂ during the phase separation.

### EVALUATION EXAMPLE 3

### Transmission Electron Microscopy (TEM) and Energy Dispersive Spectrometry (EDS)

The composite positive electrode active materials prepared in Example 1 and Comparative Example 2 were analyzed by TEM and EDS. The TEM and EDS analysis was performed using a JEM-ARM200F microscope (available from JEOL Ltd.).

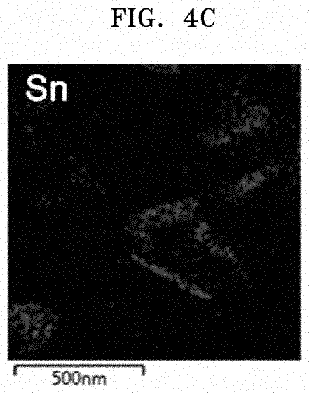

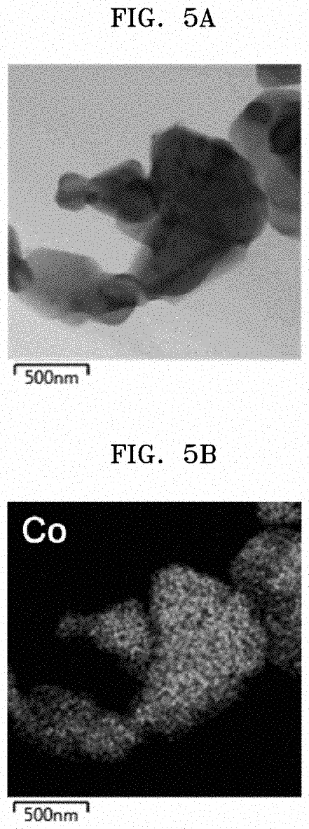

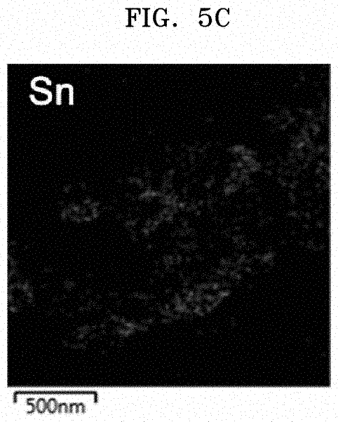

The TEM and EDS analysis results of the composite positive electrode active material of Example 1 are shown in FIGS. 4A to 4C. The TEM analysis results of the composite positive electrode active material of Comparative Example 2 are shown in FIGS. 5A to 5C.

To identify the shape of the Li₂SnO₃ coating film, transmission electron microscopy-energy dispersive spectroscopy (TEM-EDS) was performed using a scanning transmission electron microscope (STEM). The results are shown in FIGS. 4A to 4C. In particular, a sample was prepared by slicing the cross-section of particles using an ion-slicer in order to identify the shape of the coating film, and then observed using STEM.

Referring to FIGS. 4A to 4C, the composite positive electrode active material of Example 1 was found to have the Sn-containing coating film only on a specific plane of LiCoO₂ (see, e.g., FIG. 4C). In comparison, in the composite positive electrode active material of Comparative Example 2, which was cooled down at a higher cooling rate than the composite positive electrode active material of Example 1, sufficient time was not secured for Sn, which was in a doped state at high temperature, to diffuse toward the surface of LiCoO₂, and thus, Sn was present in a phase-separated state inside (within) the LiCoO₂ particles (see FIGS. 5A to 5C).

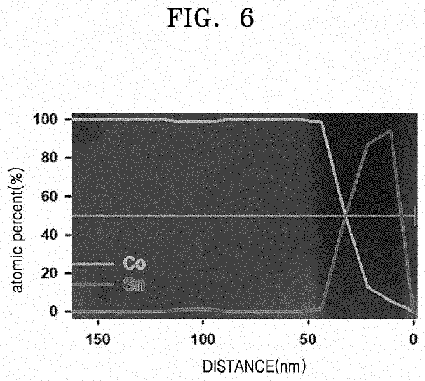

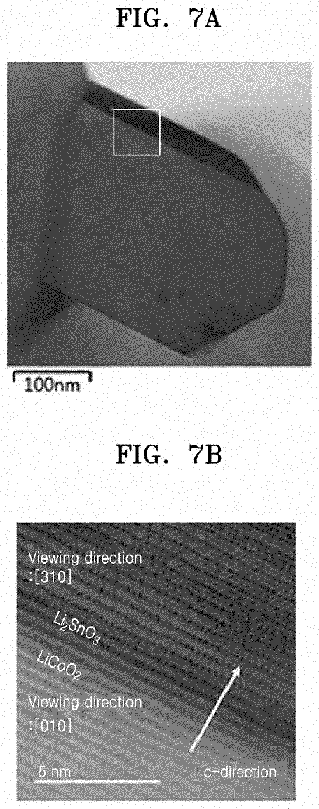

To identify the thickness and shape of the Li₂SnO₃ coating film of the composite positive electrode active material prepared in Example 1, TEM-EDS analysis using STEM was performed. The results are shown in FIG. 6. In FIG. 6, the x-axis distance refers to the radius (distance) from the surface of the composite positive electrode active material along a vector toward the center thereof. In FIG. 6, when the diameter is 0 nm, this corresponds to the surface of the composite positive electrode active material. The region near a distance of 150 nm indicates the center of composite positive electrode active material.

As shown in FIG. 6, as a result of analysis of the cross-section of particles coated with Li₂SnO₃ with an EDS line profile, it was found that the Li₂SnO₃ coating film was formed with a thickness of about 50 nm.

### EVALUATION EXAMPLE 4

### STEM and Fast Fourier Transformation (FFT) Analysis

The composite positive electrode active material prepared in Example 1 was analyzed using scanning transmission electron microscopy (STEM) and FFT analysis. The STEM and FFT analysis was performed using a JEM-ARM200F microscope (available from JEOL Ltd.).

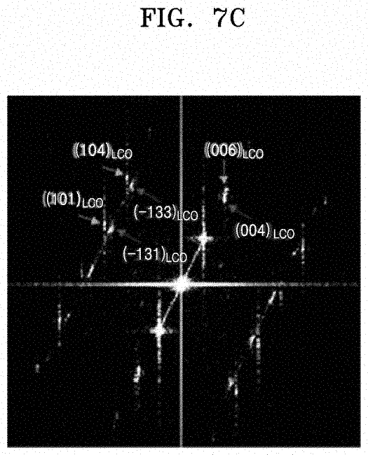

The STEM and FFT analysis results are shown in FIGS. 7A to 7C. FIG. 7A is a STEM-EDS mapping image of the composite positive electrode active material of Example 1, and FIG. 7B, which is a magnification of the rectangular region in FIG. 7A, is an enlarged STEM image showing the atomic arrangement at the boundary between LiCoO₂ and the Li₂SnO₃ coating film. FIG. 7C illustrates a FFT pattern in the STEM image of FIG. 7B.

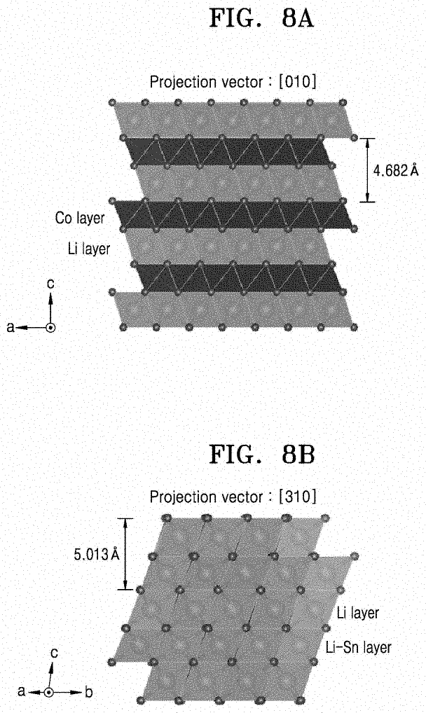

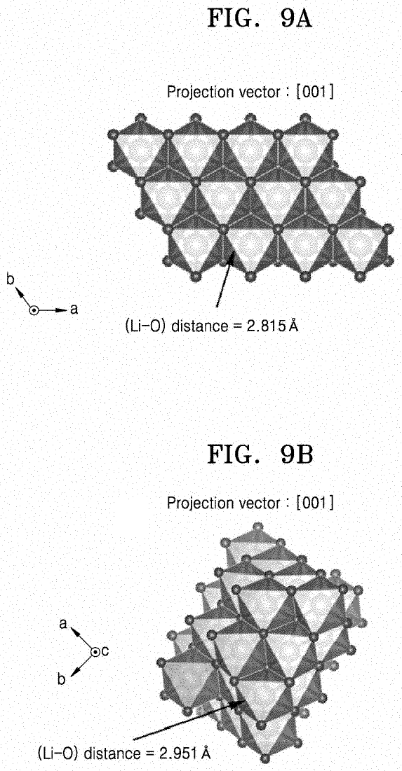

Through these analyses, the growth direction of the coating film was observed. As a result of observing, through STEM images, the atomic arrangement of LiCoO₂ and the Li₂SnO₃ coating film, and a FFT pattern of LiCoO₂ and the Li₂SnO₃ coating film, it was found that the LiCoO₂ and the Li₂SnO₃ coating film were both (e.g., similarly) grown to form a layered structure in the same c-axis direction. This indicates that, on the (003) crystal plane of LiCoO₂ having a layered structure, the Li₂SnO₃ coating film also having a layered structure was grown with sharing the (002) plane, the two materials both (e.g., similarly) being epitaxially grown in the c-axis direction. The reason for this is that, as shown in FIG. 7A, when the two layered structures share the c-axis crystal plane, a mismatch is smallest at the phase boundary between the two materials. For example, the mismatch when the two layered structures share the c-axis crystal plane is about 0.1 Å, as illustrated in FIGS. 9A-9B. However, when other planes, (e.g., the a-axis and b-axis crystal planes) are shared, a mismatch between [lithium-oxygen-transition metal-oxygen] layers is about 0.3 Å, as illustrated in FIGS. 8A-8B. This mismatch is much larger than that when the c-axis crystal plane is shared (FIGS. 9A-9B), making the phase boundary unstable. For example, to reduce mismatches between these two materials, when phase separation of Sn doped at high temperature occurs during cooling, the Li₂SnO₃ coating film selectively precipitates and is coated only on the (003) plane of LiCoO₂

### EVALUATION EXAMPLE 5

### Output Characteristics Analysis

The output characteristics (e.g., rate capacity characteristics) of the coin cells manufactured according to Manufacture Example 1 and Comparative Manufacture Example 2 were evaluated according to the following method.

The coin cells manufactured according to Manufacture Example 1 and Comparative Manufacture Example 1 were charged with a constant current at a rate of 0.1 C until a voltage of 4.5 V was reached, and then discharged with a constant current at a rate of 0.1 C to 3.0 V (1^{st} cycle). The 2^{nd} cycle and 3^{rd} cycle were repeated under the same condition as the 1^{st} cycle.

The lithium secondary battery after the 3^{rd} cycle was charged with a constant current at a rate of 0.2 C until a voltage of 4.5 V was reached, and then discharged with a constant current at a rate of 0.2 C until a voltage of 3.0 V was reached (4^{th} cycle). The 5^{th} cycle and 6^{th} cycle were repeated under substantially the same condition as the 4^{th} cycle.

The lithium secondary battery after the 6^{th} cycle was charged with a constant current at a rate of 0.5 C until a voltage of 4.5 V was reached, and then discharged with a constant current at a rate of 0.5 C until a voltage of 3.0 V was reached (7^{th} cycle). The 8^{th} cycle and 9^{th} cycle were repeated under substantially the same condition as the 7^{th} cycle.

The lithium secondary battery after the 9^{th} cycle was charged with a constant current at a rate of 1.0 C until a voltage of 4.5 V was reached, and then discharged with a constant current at a rate of 1.0 C until a voltage of 3.0 V was reached (10^{th} cycle). The 11^{th} cycle and 12^{th} cycle were repeated under substantially the same condition as the 10^{th} cycle.

The lithium secondary battery after the 13^{th} cycle was charged with a constant current at a rate of 2.0 C until a voltage of 4.5 V was reached, and then discharged with a constant current at a rate of 2.0 C until a voltage of 3.0 V was reached (13^{th} cycle). The 14^{th} cycle and 15^{th} cycle were repeated under substantially the same condition as the 13^{th} cycle.

The lithium secondary battery after the 15^{th} cycle was charged with a constant current at a rate of 5.0 C until a voltage of 4.5 V was reached, and then discharged with a constant current at a rate of 5.0 C until a voltage of 3.0 V was reached (16^{th} cycle). The 17^{th} cycle and 18^{th} cycle were repeated under substantially the same condition as the 16^{th} cycle.

The lithium secondary battery after the 18^{th} cycle was charged with a constant current at a rate of 7.0 C until a voltage of 4.5 V was reached, and then discharged with a constant current at a rate of 7.0 C until a voltage of 3.0 V was reached (19^{th} cycle). The 19^{th} cycle and 21^{st} cycle were repeated under substantially the same condition as the 19^{th} cycle.

The lithium secondary battery after the 21^{st} cycle was charged with a constant current at a rate of 10 C until a voltage of 4.5 V was reached, and then discharged with a constant current at a rate of 10.0 C until a voltage of 3.0 V was reached (22nd cycle). The 23rd cycle and 24^{th} cycle were repeated under substantially the same condition as the 22^{nd} cycle.

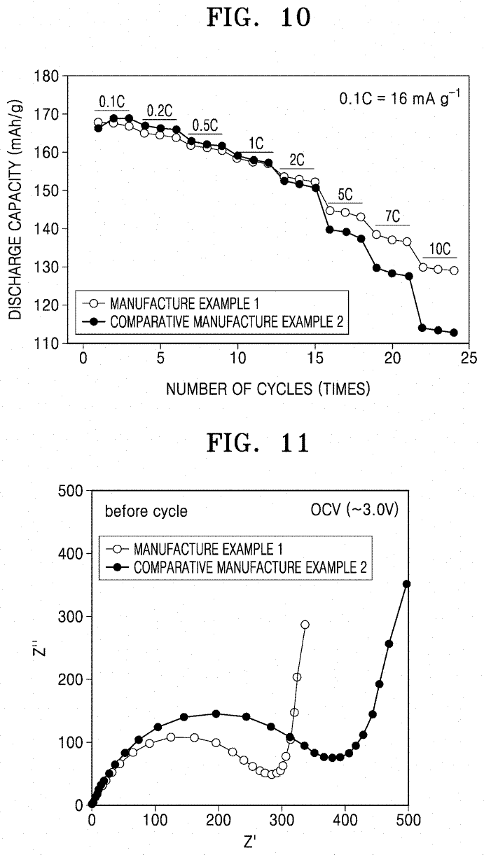

The output characteristics of the coin cells manufactured according to Manufacture Example 1 and Comparative Manufacture Example 2 are shown in FIG. 10.

Referring to FIG. 10, the coin cell of Manufacture Example 1 was found to have improved output characteristics, as compared with the coin cell of Comparative Manufacture Example 2.

The output characteristics of the coin cells of Manufacture Examples 4 and 5 were evaluated in substantially the same manner as applied above to the coin cell of Manufacture Example 1.

As shown by the evaluation, the coin cells of Manufacture Examples 4 and 5 exhibited equivalent output characteristics to those of the coin cell of Manufacture Example 1.

### EVALUATION EXAMPLE 6

### Impedance

The charge transfer resistance of the composite positive electrode active material of Example 1 and the composite positive electrode active material of Comparative Example 2 were measured using an AC impedance method at open-circuit voltages (OCV). The measurement results are shown in FIG. 11.

The results in FIG. 11 show the charge transfer resistance values analyzed using the AC impedance method. For example, the composite positive electrode active material in which only the (003) plane was coated (Manufacture Example 1) had a smaller charge transfer resistance than the composite positive electrode active material in which the entire planes of LiCoO₂ were coated through existing wet coating and quick cooling (Comparative Manufacture Example 2) due to smooth intercalation/deintercalation of lithium, thus leading to improved output characteristics.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

While one or more embodiments have been described with reference to the drawings, it will be understood by those of ordinary skill in the art that various changes in form and details may be made therein without departing from the spirit and scope of the disclosure as defined by the following claims and equivalents thereof.

DESCRIPTION OF AT LEAST SOME OF THE SYMBOLS

| | |
|---|---|
| 1: Lithium transition metal oxide having | |
| α-NaFeO₂ layered crystal structure | |
| 2: Coating film including lithium metal oxide | |
| 11: Lithium secondary battery | 12: Negative electrode |
| 13: Positive electrode | 14: Separator |
| 15: Battery case | 16: Cap assembly |

What is claimed is:

1. A composite positive electrode active material comprising:
a lithium transition metal oxide having an α-NaFeO₂ layered crystal structure; and
a coating film comprising a lithium metal oxide on a (003) crystal plane of the lithium transition metal oxide.

2. The composite positive electrode active material of claim 1, wherein the lithium metal oxide has a C2/c space group structure.

3. The composite positive electrode active material of claim 1, wherein the lithium metal oxide is a compound represented by Formula 1:
Li₂MO₃, [Formula 1]
wherein, in Formula 1, M is a metal having an oxidation number of +4.

4. The composite positive electrode active material of claim 3, wherein the lithium metal oxide is at least one selected from Li₂SnO₃, Li₂ZrO₃, Li₂TeO₃, Li₂RuO₃, Li₂TiO₃, Li₂MnO₃, Li₂PbO₃, Li₂HfO₃, and combinations thereof.

5. The composite positive electrode active material of claim 1, wherein an amount of the lithium metal oxide is 5 mol % or less based on a total amount of the lithium transition metal oxide and the lithium metal oxide.

6. The composite positive electrode active material of claim 1, wherein the lithium transition metal oxide having an α-NaFeO₂ layered crystal structure is lithium cobalt oxide (LiCoO₂); or a compound comprising lithium cobalt oxide (LiCoO₂) and at least one element selected from magnesium (Mg), calcium (Ca), strontium (Sr), titanium (Ti), zirconium (Zr), boron (B), aluminum (Al), and fluorine (F).

7. The composite positive electrode active material of claim 1, wherein the coating film has a thickness of about 1 nm to about 100 nm.

8. The composite positive electrode active material of claim 1, wherein the lithium transition metal oxide having an α-NaFeO₂ layered crystal structure, and the lithium metal oxide on the (003) crystal plane of the lithium transition metal oxide each have a layered structure epitaxially grown in the same c-axis direction.

9. A method of preparing the composite positive electrode active material of claim 1, the method comprising:
mixing a solvent, a lithium precursor, a metal (M) precursor of the lithium metal oxide, and a metal precursor of the lithium transition metal oxide having an α-NaFeO₂ layered crystal structure to obtain a composite positive electrode active material precursor composition;
adding a chelating agent to the composite positive electrode active material precursor composition and mixing the resultant to form a gel;
performing a first thermal treatment on the gel to obtain a first thermal treatment product; and
performing a second thermal treatment on the first thermal treatment product and then cooling the same at a cooling rate of about 5° C./min or less.

10. A method of preparing the composite positive electrode active material of claim 1, the method comprising:
mixing a solvent, a lithium precursor, and a metal (M) precursor of the lithium metal oxide to obtain a lithium metal oxide precursor composition;
adding, to the lithium metal oxide precursor composition, the lithium transition metal oxide having an α-NaFeO₂ layered crystal structure, and mixing the resultant to form a gel;
performing a first thermal treatment on the gel to obtain a first thermal treatment product; and
performing a second thermal treatment on the first thermal treatment product and then cooling the resultant at a cooling rate of about 5° C./min or less.

11. The method of claim 9, wherein the cooling rate is about 1° C./min to about 5° C./min.

12. The method of claim 9, wherein the first thermal treatment is performed at a temperature of about 200° C. to about 550° C.

13. The method of claim 9, wherein the second thermal treatment is performed at a temperature of about 600° C. to about 950° C.

14. The method of claim 9, wherein the metal (M) precursor of the lithium metal oxide is at least one selected from tin chloride (SnCl₂), zirconium chloride (ZrCl₄), tellurium chloride (TeCl₄), ruthenium chloride (RuCl₄), titanium chloride (TiCl₄), manganese chloride (MnCl₄), hafnium chloride (HfCl₄), lead chloride (PbCl₄), zirconium nitrate, zirconium acetate, zirconium(IV) acetylacetonate, zirconium oxalate, tellurium nitrate, tellurium acetate, tellurium oxalate, tellurium chloride, ruthenium nitrate, ruthenium acetate, ruthenium oxalate, titanium nitrate, titanium acetate, titanium oxalate, manganese nitrate, manganese acetate, manganese oxalate, hafnium nitrate, hafnium acetate, hafnium oxalate, and combinations thereof.

15. The method of claim 9, wherein the metal precursor of the lithium transition metal oxide having an α-NaFeO₂ layered crystal structure is at least one selected from cobalt nitrate, cobalt acetate, cobalt oxalate, and cobalt chloride.

16. The method of claim 9, wherein the lithium precursor is lithium hydroxide, lithium nitrate, lithium acetate, lithium sulfate, lithium fluoride, or any mixture thereof.

17. A lithium secondary battery comprising a positive electrode comprising the composite positive electrode active material of claim 1.

18. The lithium secondary battery of claim 17, wherein the lithium metal oxide is at least one selected from Li₂SnO₃, Li₂ZrO₃, Li₂TeO₃, Li₂RuO₃, Li₂TiO₃, Li₂MnO₃, Li₂PbO₃, Li₂HfO₃, and combinations thereof.

19. The lithium secondary battery of claim 17, wherein an amount of the lithium metal oxide is 5 mol % or less based on a total amount of the lithium transition metal oxide and the lithium metal oxide.

20. The lithium secondary battery of claim 17, wherein the lithium transition metal oxide having an α-NaFeO₂ layered crystal structure, and the lithium metal oxide on the (003) crystal plane of the lithium transition metal oxide each have a layered structure epitaxially grown in the same c-axis direction.
